(19) United States
(12) Patent Application Publication
(10) Pub. No.: US 2022/0178452 A1
(43) Pub. Date: Jun. 9, 2022

(54) DIVERTER VALVE FOR FLUIDS

(71) Applicant: Mauro BOZZOLAN, CALDARO Sulla Strada Del Vino (BZ) (IT)

(72) Inventor: Mauro BOZZOLAN, CALDARO Sulla Strada Del Vino (BZ) (IT)

(21) Appl. No.: 17/598,254

(22) PCT Filed: Feb. 14, 2020
(86) PCT No.: PCT/IB2020/051238

§ 371 Date: Sep. 25, 2021

(30) Foreign Application Priority Data
Mar. 29, 2019 (IT) 102019000004781

(51) Int. Cl. F16K 11/07

(52) U.S. Cl. CPC F16K 11/0712

(57) ABSTRACT

A diverter valve for fluid circulation circuits comprising a valve body provided with ports for the passage of the fluid, a pin slidingly mounted inside said body and at least one shutter combined with said pin so that to be able to slide and comprising a deformable element. A first and a second end portion of the valve body are combined with a first and a second fixed element arranged so that the first fixed element causes the compression of the deformable element following the sliding of the pin in a first direction, making it expand radially to define a fluid seal with the valve body in a first position, and the second fixed element causes the compression of the deformable element following the sliding of the pin in a second direction, making it expand radially to define a fluid seal with the valve body in a second position.

### FIELD OF THE INVENTION

The present invention generally concerns the sector of multi-way valves for fluids, and in particular, the valves of the piston type for the distribution of fluids.

### STATE OF THE ART

The hydraulic and aeraulic circuits usually provide for the use of shut-off valves to manage the flow of a fluid. Such valves comprise at least two ports for the inflow and/or outflow of the fluid. For example, the water treatment systems are normally provided with multi-way valves to block the flow of water or to channel it towards a desired outlet of the system from time to time. Pneumatic valves comprising a substantially tubular valve body having two or more ports, preferably at least three, and a control element in the shape of a stem bearing at least one shutter movable so that to slide inside the body itself, are known in this sector. The shutter normally consists of a disc having two circular surfaces or anyhow complementary to the inner shape of the tube, each of which is combined with a gasket. Such shutter is moved by the pin so that to be displaced inside the tubular body between at least two positions, in each of which it is pushed against a respective abutment portion Obtained inside the tube itself, so that to prevent the flow of fluid at least in one part of the tubular body, thanks to the seal that is formed between the gasket and the abutment portion. Thus, depending on the position of the shutter, it will be possible to isolate the inlet port from the outlet ports, or to fluidically connect at least one inlet port with at least one outlet port according to need. The stem is normally moved automatically by an actuator of the pneumatic type. Valves of such structure can also be used for aeraulic systems in which an aeriform fluid runs.

However, this configuration has some disadvantages. Firstly, the tubular body must have at least an abutment portion consisting of a narrowing of the inner circumference of at least one length of the tubular body itself. Such narrowing implies additional costs for the production of the tubular body, which ends up having lengths with different sections and thus an irregular inner surface, especially in the event of valves having various ports, such as 5-way valves, which are particularly used in various types of hydraulic systems to carry out, for example, the cleaning of filters for the water treatments. Moreover, each narrowing of the tubular body necessarily involves load losses, thus reducing the flow rate of the fluid.

In addition, the gaskets are combined with the surfaces of the shutter in a way such as not to be able to be detached and are thus difficult to replace when worn. Finally, the pneumatic actuation is complex and also has complexities during the installation step of the valve, due to the presence of additional components to allow its operation.

The documents U.S. Pat. Nos. 2,735,439, 1,781,224 and 317,438 concern valves comprising a shutter having a fixed portion and a movable portion, in-between which a gasket is arranged and which is deformed by crushing when, following a movement of the shutter in a direction, the movable portion moves closer to the fixed portion. However, such solution is only applicable to valves of a different type with respect to those object of the present invention since, due to how they are structured, the compression can occur following the movement in only one direction and at only one point of the valve.

### OBJECTS AND SUMMARY OF THE INVENTION

Object of the present invention is to overcome the drawbacks of the known art, by providing a diverter valve having a body with a substantially uniform inner section, i.e. devoid of abutment elements inside it, to ensure the fluid seal between the shutter and the body itself, thus allowing to fluidically connect different ports of the same valve from time to time.

A further object is to provide a diverter valve that allows a constant flow rate of the fluid.

A further object is to propose a diverter valve having a particularly linear valve body and which can be produced by molding.

Yet a further object is to provide a diverter valve structured so that to facilitate the dismantling and maintenance steps.

Yet a further object is to propose a diverter valve that can be automatically operated, with a simplified actuation.

The present invention thus concerns a diverter valve for circuits inside which a liquid or aeriform fluid circulates according to claim 1.

In particular, the valve comprises a pin bearing at least one shutter and slidingly mounted inside the valve body itself. The shutter is in turn slidingly mounted with respect to the pin and comprises an element deformable by crushing and susceptible to radial expansion, when at least one of the shutters is pressed against one or the other of the two fixed elements inside the valve body. When crushed and, thus, radially expanded, the deformable element comes into contact with a section of the inner surface of the valve body, thus creating a mechanical fluidic seal therewith, so that to channel the fluid in a desired portion of the valve from time to time.

Thus, advantageously, the use of a deformable element, in the form of a radially expandable gasket, allows to create a seal with the valve body without requiring any abutment element inside the valve body. In fact, the valve body does not have to have narrowings in the desired positions, since the gasket itself is expanded at the desired portions by mechanical compression caused by the respective fixed element against which it is pressed.

Preferably, each shutter comprises or is combined with two supporting elements, which are also slidingly combined with the pin and in-between which the deformable element is arranged and which, when they are moved closer to one another by the fixed element and by the thrust or traction exerted on the pin, favor the compression of the deformable element of each shutter, so that to ensure the proper seal.

Thus, each shutter can be moved between two different positions, in each of which the deformable element is deformed to stop the flow of fluid or to connect different ports of the valve, depending on the position taken. Thus, during the displacements of the pin, the deformable element is instead in a resting condition, in which its size becomes less than the inner size of the valve body so that to be able to slide inside it.

Thus, advantageously, the valve body is structurally very simple, since there are no narrowings inside it and is thus very simple to produce, for example by molding. In addition, and advantageously, it does not have any narrowing that can reduce the flow rate.

Advantageously, the pin has a first and a second abutment portion, each intended to come into contact with, or closer to, a respective supporting element of the respective shutter, so that to keep it in a predetermined position with respect to the pin itself. This way, following the movement of the pin in a direction, one of the two supporting elements abuts against the first or the second fixed element; the further movement of the pin in the same direction also causes the movement of the abutment portions and, thus, one of them starts to press against the respective supporting element, pushing it towards the other supporting element which is instead restrained by the fixed element, thus causing a deformation and, specifically, a radial expansion of the deformable element of the shutter.

Preferably, the pin has at least one intermediate part having a first cross-section sized to be inserted in a pass through hole obtained in each shutter and two extensions on opposite sides of the intermediate part, each having at least one portion with a cross-section of greater size than that of the pass-through hole. Whenever there is more than one shutter, at least one spacing element, also having a greater section than that of said hole and intended to keep the shutters at a predetermined distance from one another, is preferably combined with the intermediate part of the pin. More preferably, at least one end part and even more preferably both the extensions of the pin are removably combined with the intermediate part, for example by screwing, to allow to easily and quickly combine each shutter with the pin. This facilitates both the initial assembling step and the subsequent steps, whenever parts of the shutter need to be replaced.

Preferably, both the deformable element and the supporting elements have an outer profile complementary to that of the valve body, but of slightly smaller size. Preferably, they have a circular profile and even more preferably the supporting elements are in the form of discs, while the deformable element can also be in the form of a disc, or can have an annular shape and can only be combined with a peripheral part of the supporting elements.

Advantageously, a first and a second end portion can be removably combined with the valve body, so that to be removed according to need to be able to carry out maintenance and/or cleaning operations of the valve. In turn, the first and the second fixed elements can be an integral part of the first and of the second end portions, or separate elements combined therewith in a fixed and removable way, otherwise or in addition they can also be combined with the extensions of the pin, so that, following the sliding of the pin in a first or a second direction opposite from one another, one of them alternately abuts and stops against one of the end portions of the valve, to restrain the respective supporting element and to cause the compression of the deformable element.

Preferably, automatic driving means of the electric type, which can be operated manually or automatically, are combined with the valve. Such means can comprise a driving actuator. The use of electric driving means further simplifies the structure of the valve, since it eliminates the need to provide it with or to connect it to a compressor, which is required in case of pneumatic valves.

Advantageously, whenever the valve is of the 2-way type, a single shutter, having the task of allowing or blocking the flow of the fluid between an inlet port and an outlet port, is combined with the pin; if the valve is of the three-way type, a single shutter which, depending on the position, can channel the flow of the fluid between a first port and one of two different second ports, can be combined with the pin; whenever the valve is of the 5-way type, two shutters can be combined with the pin so that, when in a first position, they can fluidically connect an inlet port with an outlet port, thus forcing the passing through two intermediate ports, whereas, when in a second position, they can fluidically connect an inlet port with a different outlet port, thus forcing the passing of the fluid through two intermediate ports and reversing the crossing direction of such intermediate ports.

### LIST OF THE FIGURES

Further characteristics and advantages of the invention will be better highlighted by the review of the following detailed description of a preferred, but not exclusive, embodiment illustrated by way of example and without limitations, with the aid of the accompanying drawings, in which:

FIG. 1 is a perspective view of an embodiment of a diverter valve according to the present invention;

FIGS. 2a, 2b and 2c each show a section of the valve of FIG. 1 in a resting condition and in two different working conditions;

FIGS. 3a, 3b and 3c show a partial section of some inner components of the valve of FIG. 1, respectively in the resting condition and in the two working conditions of FIGS. 2a, 2b and 2c;

FIGS. 4a and 4b each show a section of a different embodiment of the valve according to the invention, in two different working conditions;

FIGS. 5a, 5b and 5c each show a section of a further embodiment of the valve according to the invention, in a resting condition and in two different working conditions;

FIGS. 6a, 6b and 6c show a partial section of some inner components of the valve of FIGS. 5a, 5b and 5c, respectively in the resting condition and in the two working conditions; and

FIGS. 7a, 7b and 7c show a section of some of the inner components of the valve shown in FIG. 3a.

### DETAILED DESCRIPTION OF THE INVENTION

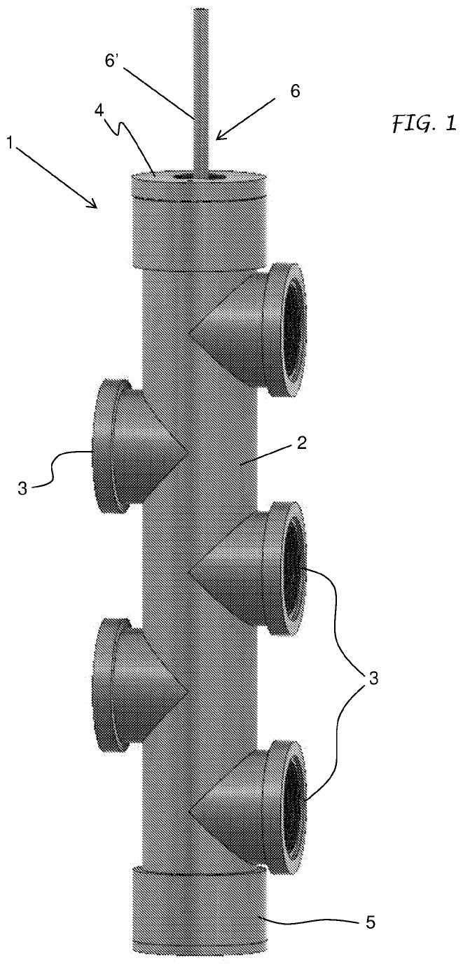

FIG. 1 shows a diverter valve 1 according to the present invention, for hydraulic o aeraulic circuits, in which a fluid, which can be liquid or aeriform, circulates.

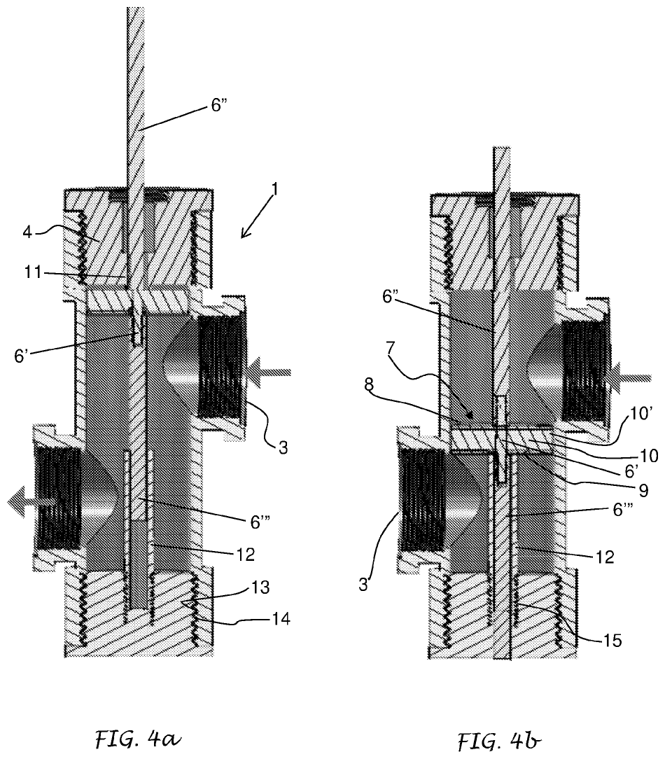

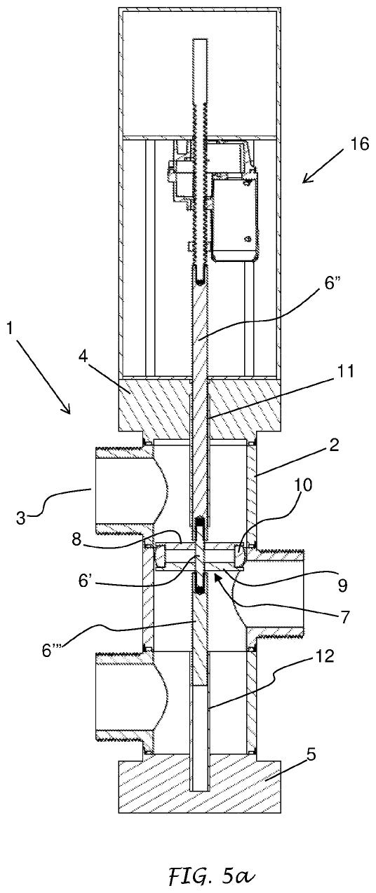

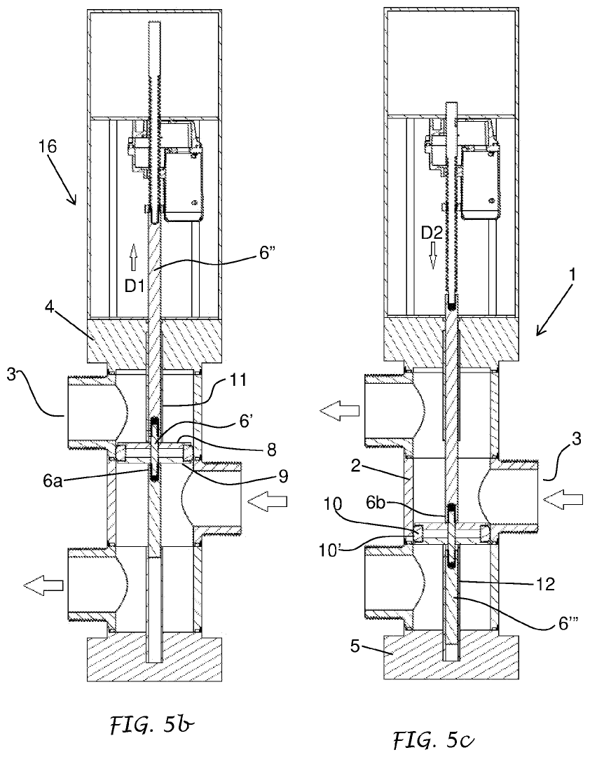

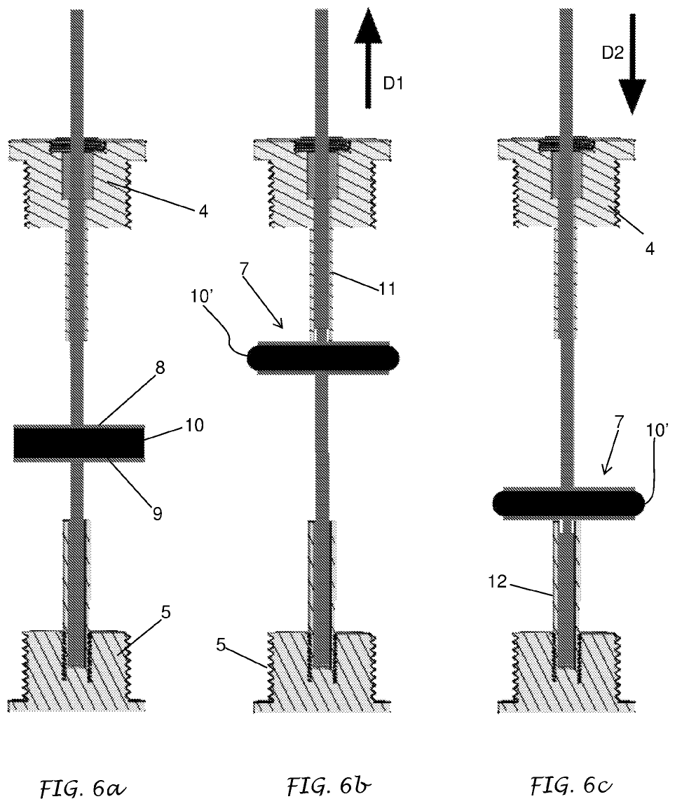

The valve comprises a hollow, preferably substantially tubular, valve body 2 having at least two ports 3 for the inflow and/or outflow of fluid into/from the valve. Preferably, the valve can be a 2-way valve, as shown in FIGS. 4a and 4b, or a 3-way valve, as shown in FIGS. 5a, 5b, 5c, 6a, 6b, and 6c, or a 5-way valve, as shown in FIGS. 1, 2a, 2b, 2c, 3a, 3b and 3c. The body can be made of a plastic material, stainless steel, or any other material and extends between a first end portion 4 and a second end portion 5.

The valve further comprises a pin 6 provided with one or more shutters 7. The pin is combined with the valve body so that to slide inside it, alternately in a first direction D1 and in a second direction D2 opposite the first direction.

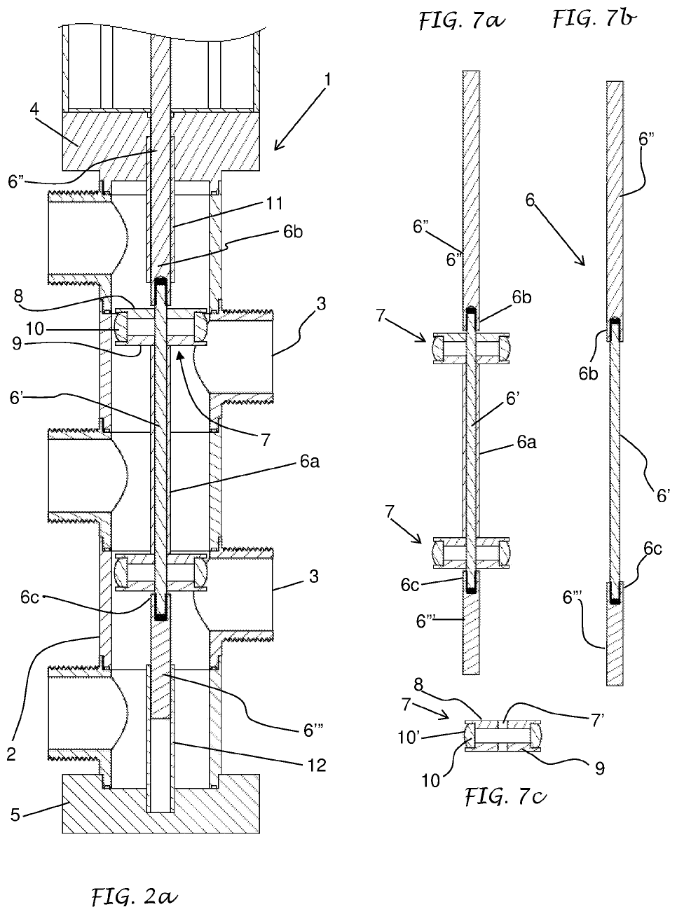

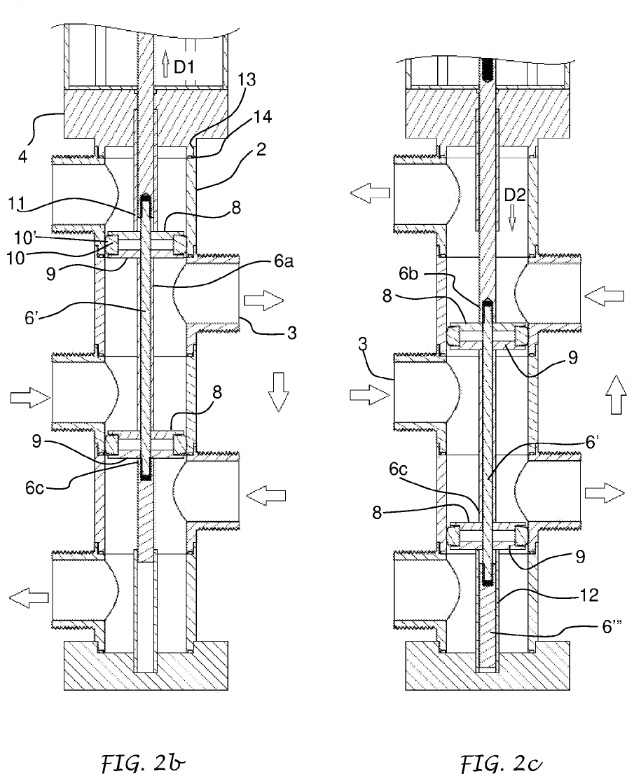

Each shutter has a shape complementary to the inner section of the body and is sized to be able to slide inside it. In case of a valve body with a circular section, each shutter is in the form of a disc having a diameter slightly smaller than that of the inner circumference of the tube, so that to be able to slide inside it, when in a resting position, as shown in FIGS. 2a, 3a, 5a and 6a.

According to the invention, each shutter is combined with the pin so that to be able to slide with respect to it and can comprise or be combined with a first supporting element 8 and a second supporting element 9 between which a deformable element 10, of the type able to radially expand when subjected to pressure, such as a gasket sealing by crushing, is arranged. The first and the second supporting elements are slidingly mounted on the pin so that to be movable one with respect to the other such as to be able to move closer or away from one another. In case of a shutter with a circular section, it comprises a circular gasket, preferably in the form of a disc, arranged between two supporting elements, also in the form of discs made of a rigid material. Advantageously, and as shown in FIG. 7a, each shutter 7 has a pass-through hole 7′, preferably in a central position thereof, in which the pin is inserted. Preferably, the deformable element is a small centrally-perforated disc or a ring made of silicone or synthetic rubber, such as rubber of the EPDM type.

The pin comprises an intermediate part 6′ having a first cross-section, sized to be able to be inserted in said pass through hole 7′, and a first and second extension 6″ and 6′″, each extending from a respective end of the intermediate part, as shown in particular in FIG. 7b.

Each shutter is combined with the intermediate part 6′ of the pin and is kept in a predefined position by a first abutment portion 6b and a second abutment portion 6c of the first and the second extension of the pin and by at least one possible spacing element 6a, whenever there is more than one shutter, each to be combined with the intermediate part such as to be arranged between a respective couple of shutters, as shown in detail in FIG. 7a. At least the first and the second abutment elements, but preferably the entire first and the entire second extensions of the pin, have a second cross-section sized so that to not allow the insertion of the shutter in said pass-through hole 7′. At least the ends, but preferably the entire spacing element, has a third cross-section also sized so that to not allow the insertion of the shutter in said pass-through hole 7′. Preferably, the second and the third cross-sections are equal.

Advantageously, the first and the second extension of the pin are separate elements, preferably removably combined with the intermediate part, for example by screwing.

A first fixed element 11 and a second fixed element 12 are respectively combined with the first and the second end portions 4, 5 of the tubular body. The two fixed elements are hollow so that to each accommodate a respective first or second extension of the pin and to allow it to slide inside it.

This way, when the pin is moved in the first direction D1, following the displacement, the first supporting element 8 comes into contact with the first fixed element 11 and the shutter is pressed against it. Since the pin can slide with respect to the shutter, a further displacement thereof in the direction D1 also causes a displacement of the second end extension and, with it, of the second abutment portion, which is pressed against the second supporting element 9 of the shutter, so that to move it closer to the first supporting element 8, thus causing the compression and the consequent radial expansion of the deformable element, which emerges with respect to the surfaces of the supporting elements, as shown in FIGS. 2b, 3b, 5b and 6b, thus pressing on the inner surface of the valve body to ensure a mechanical seal against the hydraulic force of the fluid and to force it to follow the desired direction, as shown in FIGS. 2b and 5b.

Vice-versa, when the pin is moved in the direction D2, following the displacement, the second supporting element 9 comes into contact with the second fixed element 12 and the shutter is pressed against it. Since the pin can slide with respect to the shutter, a further displacement thereof in the direction D2 also causes a displacement of the first extension and, with it, of the first abutment portion, which is pressed against the first supporting element 8 of the shutter, thus moving it closer to the second abutment element and causing the radial expansion of the deformable element, which emerges at least partially with respect to the surfaces of the supporting elements, as shown in FIGS. 2c, 3c, 5c and 6c, and presses on the inner surface of the valve body to ensure a mechanical seal against the hydraulic force of the fluid to force it to follow the desired direction, as shown in FIGS. 2c and 5c.

In case of the 2-way valve which is shown in FIGS. 4a and 4b, when the pin is moved in a direction, following the displacement, the first supporting element 8 comes into contact with the first fixed element, or anyhow with the first end portion 4 of the valve body, so that to fluidically connect the two ports of the valve to one another and to allow the fluid to run inside the valve, as shown in FIG. 4a; vice-versa, when the pin is moved in the opposite direction, following the displacement, the second supporting element 9 comes into contact with the second fixed element 12 and, thanks to the thrust exerted by the first abutment portion 6b, the first supporting element 8 is moved closer to the second supporting and compresses the deformable element 10, which emerges with respect to the surfaces of the outer portions and presses on the inner surface of the valve body so that to ensure a mechanical seal against the thrust of the fluid, so that to isolate the two ports from one another and to prevent the passing of the fluid in the valve, as shown in FIG. 4b.

Advantageously, the first and the second end portions of the valve are elements separate from the valve body and are removably combined therewith, for example by screwing, For this, each end portion has first hooking means 13, such as a thread, and the valve body has corresponding second hooking means 14, such as a thread, intended to couple with the first hooking means. The first and the second fixed elements can be an integral part of the respective first and second end portions, or separate elements combined therewith in a fixed but preferably removable way, by means of respective hooks 15 so that to be able to combine fixed elements of different sizes depending on the type and size of the valve itself.

This configuration allows to have a valve body with an almost continuous inner surface except for the openings corresponding to the ports and this advantageously allows to obtain the valve body by molding.

A driving actuator 16 is combined with the valve—shown in FIGS. 5a, 5b and 5c. The actuator can be operated manually, for example by means of a switch, or automatically, for example by means of a pressure switch. Preferably and thanks to its configuration, the valve can be combined with an actuator of the electric type, thus significantly simplifying it with respect to the known valves, which must be driven by pneumatic actuators. The driving actuator is combined with the pin 6 and, specifically, with the first or the second extension 6″, 6″′ to cause its movement in the direction D1 or in the direction D2 as needed. The particular structure of the valve allows the use of an electric actuator, with respect to the valves of the known art which require a pneumatic actuator, since the deformable element also acts as a damper to compensate possible imprecisions of the actuator during the travel of the piston. Thanks to the particular configuration of the valve, it is possible to cause the expansion of the deformable element in two different directions and positions of the actuator with respect to the valve body by using a single actuator, both when the shutter is pulled against the first fixed element and when it is pushed against the second fixed element; in addition, it is also possible to cause the almost instantaneous expansion of each of the deformable elements of at least two shutters in different positions, so that to be able to also drive, always with a single actuator, a 5-way valve.

In specific, FIGS. 1, 2a, 2b and 2c show a 5-way valve, thus provided with five ports 3 that can alternatively be inlet or outlet ports of the fluid, depending on the type and method of use of the valve itself in the circuit with which it is combined. As shown, the 5-way valve comprises two shutters 7 borne by the same pin 6 and movable in the valve body so that to fluidically connect different couples of ports of the valve, as needed, so that to vary the flows of the fluid. In specific, by moving the shutters, it is possible to deviate the fluid coming in through an inlet port alternatively towards two different outlet ports, as denoted by the arrows of FIGS. 2b and 2c, by moving the shutters kept in a resting condition shown in FIG. 2a, in which the deformable element of each shutter is not expanded and thus stays detached from the inner wall of the valve body, such as not to generate frictions, which would hinder the movement of the shutters and which would cause undesired wearing of the deformable elements.

In particular, such a type of valve is widely used in the hydraulic systems in which it is necessary to carry out cleaning operations of the water treatment filters. In specific, a first working condition of the valve for the recirculation of the liquid from and to the tank containing the liquid, such as a pool or the like, is shown in FIG. 2b. In such condition, the water coming out of the tank is channeled through a filter and then sent back in the tank. FIG. 2c shows the valve in a second working condition, in which the displacement of the shutters determines a variation of the flow of the fluid. In such condition it is possible, for example, to carry out the counter-washing of the filter, by forcing the water to cross the filter in the direction opposite the filtering one, so that to allow the removal of the particles captured previously; the water is then channeled towards an outlet different from the previous one to be released, without entering the tank.

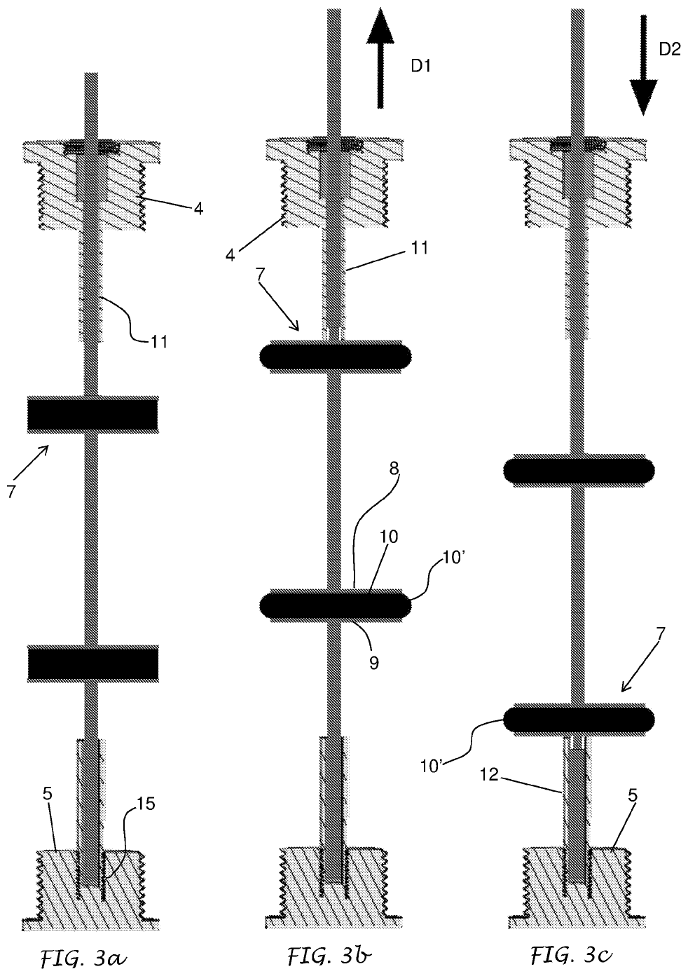

Correspondingly, the shutters in the resting condition corresponding to the movement steps are shown in FIG. 3a, while FIGS. 3b and 3c show the shutters when they are in the working positions of FIGS. 2b and 2c. As shown in FIGS. 2a and 3a, the deformable elements 10 of both the shutters are in a resting condition, in which they stay inside the first and the second supporting elements, thus allowing the shutter itself to slide in the valve body. Vice-versa, when in the working conditions shown in FIGS. 2b, 2c, 3b and 3c, the displacement of the shutters, together with the first or the second fixed element 11, 12, causes the first and the second supporting elements 8, 9 of each shutter to move closer to one another and the consequent crushing of the respective deformable element 10, so that at least its peripheral portion 10′ emerges from the respective first and second supporting elements, thus coming into contact and establishing a fluid seal with the inner surface of the valve body.

Instead, FIGS. 4a and 4b show a two-way valve. In this case, a single shutter, movable between a first position shown in FIG. 4a, in which it establishes a fluidic connection between the two ports, and a second position shown in FIG. 4b, in which the shutter is pushed against the second fixed element 12 to cause the compression of the deformable element and to thus isolate the inlet port from the outlet one, is combined with the pin.

Finally, FIGS. 5a, 5b, 5c, 6a, 6b and 6c show a 3-way valve. Also in this case, there is a single shutter for fluidically connecting an inlet with a different outlet from time to time. In specific, when the shutter 7 is pulled or pushed against the first fixed element 11, the peripheral portion 10′ of the deformable portion emerges from the supporting elements 8, 9 and defines a fluid seal with the valve body to isolate a port with respect to the other two, as shown in FIGS. 5b and 6b, while when the shutter 7 is moved in the opposite direction, so that to be pressed against the second fixed element 12, the deformable element 10 defines a fluid seal in a different position, thus allowing the passing of the fluid between two different ports and preventing the passing in the third, as shown by the arrows of FIG. 5b.

For assembling the valve, it is sufficient to prearrange a valve body having two or more ports; to combine the first or the second end portion, with which the respective first or second fixed element has in turn to be combined, with the valve body; to arrange the pin provided with the first or the second abutment portion inside the valve body, with the pin slidingly mounted inside the valve body; to slidingly combine at least one shutter provided with a deformable element, with the pin; to combine the second or the first abutment portion with the pin; to combine the second or the first fixed element with the respective second or first end portion; to combine the second or the first end portion with the valve body; and to combine the driving actuator with the pin for its movement.

Whenever the valve comprises at least two shutters, the step of interposing a respective spacing element between each couple of shutters is necessary, so that to keep the shutters at a predetermined distance, depending on the distance and the arrangement of the ports of the valve.

Advantageously, the maintenance operations are also simplified; in fact, to replace the deformable element, it is sufficient to separate the first or the second end element from the valve body, to slip off the pin with the respective shutters and to move the supporting elements away from each other in order to remove the deformable element and to replace it.

Reference was made to the 2-, 3- and 5-way valves, in specific configurations, in the description since they are the most widely used ones, but this does not exclude the fact that the same inventive concept can be applied to valves with a different number of ports and with different types of use.

1. A diverter valve for fluid circulation circuits, said diverter valve comprising:
a valve body having two or more ports for the fluid inflow and/or outflow;
a pin slidingly mounted inside said valve body; and
one or more shutters each of said one or more shutters combined with said pin and comprising a deformable element wherein
a first and a second fixed element are combined with a first and a second end portion of the valve body,
each of said one or more shutters is combined with said pin to slide with respect to each one or more shutters, and
said first fixed element configured to interact with one of said one or more shutters, causing the compression of the deformable element of each of said one or more shutters, following the sliding of the pin in a first direction, making said first fixed element expand radially such as to define a fluid seal with the valve body in a first position, and following the sliding of the pin in a second direction, opposite said first direction, said second fixed element configure to interact with one of said one or more shutters, causing the compression of the deformable element of each of said one or more shutters, making said second fixed element expand radially such as to define a fluid seal with the valve body in a second position.

2. The diverter valve according to claim 1, wherein
said first and second fixed elements are at least partially hollow for slidingly accommodating a respective portion of the pin,
each of said one or more shutters comprises a first and a second supporting element movable with respect to one another,
the deformable element arranged between said first and said second supporting elements, and
following the sliding of the pin in the first direction, the first supporting element of one of said one or more shutters is pressed against the first fixing element and the second supporting element of each of said one or more shutters is moved closer to the first supporting element of the respective shutter, causing the compression of the deformable element to make at least one peripheral portion emerge therefrom with respect to said first and second supporting elements, to define a fluid seal with the valve body, and
following the sliding of the pin in the second direction, the second supporting element of one of said one or more shutters is pressed against the second fixed element and the first supporting element of each of said one or more shutters is moved closer to the second supporting element of the respective shutter, causing the compression of the deformable element, to make at least one peripheral portion emerge therefrom with respect to said first and second supporting elements, to define a fluid seal with the valve body.

3. The diverter valve according to claim 2, wherein
each shutter of said one or more shutters comprises a pass-through hole for the insertion and sliding of the pin,
said each shutter of said one or more shutters is kept in a predefined position by means of a first abutment portion and a second abutment portion of the pin,
the first and the second abutment elements are sized so that not to be able to be inserted in said pass through hole of the shutter,
following the sliding of the pin in the first direction, the first supporting element of one of said one or more shutters is pressed against the first fixed element, the first abutment portion pushes the second supporting element of each of said one or more shutters towards the first supporting element of the respective shutter, moving closer thereto and causing the compression of the deformable element, and
following the sliding of the pin in the second direction, the second supporting element of one of said one or more shutters is pressed against the second fixed element and the second abutment portion pushes the first supporting element of each of said one or more shutters towards the second supporting element of the respective shutter, moving closer thereto and causing the compression of the deformable element.

4. The diverter valve according to claim 3, wherein
the pin comprises an intermediate part to be inserted at least partially in the pass-through hole and a first and a second extension extending from opposite parts of the intermediate part, each comprising a respective portion of said first or second abutment portion and each being sized to slide inside the respective first or second fixed element.

5. The diverter valve according to claim 4, wherein
the first and the second extensions are separate elements removably combined with the intermediate part, by screwing.

6. The diverter valve according to claim 5, wherein
at least two shutters are combined with the pin and wherein each shutter is kept in a predefined position by said first and second abutment portions and by at least one spacing element arranged between two adjacent shutters, to be combined with the intermediate part of the pin, to be arranged between a respective couple of shutters and sized so that not to be able to be inserted in said pass through hole of the shutter.

7. The diverter valve according to claim 6, wherein
each shutter and the possible first and second supporting elements have an outer profile complementary to the inner section of the valve body and are sized such as to be able to slide inside it when the deformable element is in a resting condition in which is not compressed.

8. The diverter valve according to claim 7, further comprising:
a circular-section valve body, wherein
the shutter has circular section with an outer diameter smaller than the inner diameter of the valve body, when the deformable element is in the resting condition.

9. The diverter valve according claim 1, wherein
the deformable element is made of a synthetic polymer, such as silicone, or a synthetic rubber.

10. The diverter valve according to claim 1, wherein
the first and second end portions are removably combined with the valve body, by screwing by means of respective first coupling means which are matched to corresponding second coupling means obtained at the level of the valve body, the first and second fixed elements being able to be an integral part of the respective first and second end portions, or separate elements combined therewith in a fixed or removable way.

11. The diverter valve according to claim 1, wherein
the valve body has an almost continuous inner surface, except for the openings corresponding to the ports, and does not have peripheral abutment elements emerging from its inner surface.

12. The diverter valve according to claim 1, further comprising:
a manually or automatically controlled driving actuator to move the pin alternately in the first and the second directions, wherein
said controlling means is an actuator of the electric type.

13. The diverter valve according to claim 1, wherein the diverter valve:
has two ports, and a single shutter is combined with the pin to allow or block the fluid flow between an inlet port and an outlet port;
has three ports, and a single shutter is combined with the pin to divert the fluid flow between an inlet port and two different outlet ports; or
has five ports, and two shutters are combined with the pin to divert the fluid flow between an inlet port and two different outlet ports, thus reversing the crossing direction of two intermediate ports.

14. A method for assembling a diverter valve, said method comprising:
a) prearranging a valve body having two or more ports for the inflow and/or outflow of the fluid;
b) combining a first or a second end portion with the valve body;
c) combining, respectively, a first or a second fixed element with said first or second end portion;
d) arranging a pin inside the valve body configured to be slideable within said body, said pin being provided with a first or a second abutment portion;
e) slidingly combining at least one shutter comprising a deformable element with said pin;
f) combining a second or a first abutment portion with said pin;
g) combining, respectively, the second or the first fixed element with the second or first end portion;
h) combining said first or second end portion with the valve body; and
i) combining a driving actuator with the pin for moving it in opposite directions within the valve body.

15. The method for assembling the diverter valve according to claim 14, wherein
the valve comprises at least two shutters, and
the step e) provides to interpose a spacing element between each couple of shutters, configured to keep each couple of adjacent shutters at a predefined distance from one another.

16. The diverter valve according to claim 1, wherein
each shutter of said one or more shutters comprises a pass-through hole for the insertion and sliding of the pin,
said each shutter of said one or more shutters is kept in a predefined position by means of a first abutment portion and a second abutment portion of the pin,
the first and the second abutment elements are sized so that not to be able to be inserted in said pass through hole of the shutter,
following the sliding of the pin in the first direction, the first supporting element of one of said one or more shutters is pressed against the first fixed element, the first abutment portion pushes the second supporting element of each of said one or more shutters towards the first supporting element of the respective shutter, moving closer thereto and causing the compression of the deformable element, and
following the sliding of the pin in the second direction, the second supporting element of one of said one or more shutters is pressed against the second fixed element and the second abutment portion pushes the first supporting element of each of said one or more shutters towards the second supporting element of the respective shutter, moving closer thereto and causing the compression of the deformable element.

17. The diverter valve according to claim 1, wherein
at least two shutters are combined with the pin and wherein each shutter is kept in a predefined position by said first and second abutment portions and by at least one spacing element arranged between two adjacent shutters, to be combined with the intermediate part of the pin, to be arranged between a respective couple of shutters and sized so that not to be able to be inserted in said pass through hole of the shutter.

18. The diverter valve according to claim 1, wherein
each shutter and the possible first and second supporting elements have an outer profile complementary to the inner section of the valve body and are sized such as to be able to slide inside it when the deformable element is in a resting condition in which is not compressed.

19. The diverter valve according to claim 1, further comprising:
a circular-section valve body, wherein
the shutter has circular section with an outer diameter smaller than the inner diameter of the valve body, when the deformable element is in the resting condition.
